(19) United States
(12) Patent Application Publication
(10) Pub. No.: US 2021/0297649 A1
(43) Pub. Date: Sep. 23, 2021

(54) IMAGE DATA OUTPUT DEVICE, CONTENT CREATION DEVICE, CONTENT REPRODUCTION DEVICE, IMAGE DATA OUTPUT METHOD, CONTENT CREATION METHOD, AND CONTENT REPRODUCTION METHOD

(71) Applicant: SONY INTERACTIVE ENTERTAINMENT INC., TOKYO (JP)

(72) Inventors: Shinpei YAMAGUCHI, TOKYO (JP); Junichi MURAMOTO, TOKYO (JP)

(21) Appl. No.: 17/278,290

(22) PCT Filed: Sep. 28, 2018
(86) PCT No.: PCT/JP2018/036542

§ 371 Date: Mar. 19, 2021

(51) Int. Cl. H04N 13/156; H04N 13/172; H04N 13/383; H04N 13/106; H04N 13/128

(52) U.S. Cl. CPC H04N 13/156; H04N 13/172; H04N 13/332; H04N 13/158; H04N 13/128; H04N 13/383

(57) ABSTRACT

A partial image acquiring unit 50 of an image data output device 10 acquires plural partial images photographed with different angles of view. An output image generating unit 52 connects partial images to generate data of one wide-angle image. A map generating unit 56 generates map data relating to a joint of partial images, and a data output unit 54 outputs these pieces of data. A content creation device 18 refers to the map data and enlarges a region including the joint, and detects and corrects image distortion and a discontinuous part. A content reproduction device 20 refers to the map data and connects or combines the remaining partial images as appropriate to carry out output to the display device 16b.

### TECHNICAL FIELD

The present invention relates to an image data output device that outputs an image used for displaying, a content creation device that creates content using this image, and a content reproduction device that causes this image or content using it to be displayed, and an image data output method, a content creation method, and a content reproduction method carried out by the respective devices.

### BACKGROUND ART

A camera that can photograph an omnidirectional (360°) image or an extremely-wide-angle image close to it by a fisheye lens or the like has become familiar. When an omnidirectional image photographed by such a camera is employed as a display target and is allowed to be viewed with free point of view and line of sight through a head-mounted display or cursor operation, enjoyment of the image world with a high sense of immersion and presentation of the state of various places are enabled.

### SUMMARY

### Technical Problems

When the angle of view of the image used for displaying is set wider, more dynamic image representation becomes possible whereas the size of treated data increases more. Particularly in the case of a moving image, necessary resources increase in all phases such as transmission of a photographed image, recording of data, creation of content, and reproduction. For this reason, in an environment in which the resources are not sufficient, the situation in which the image quality at the time of displaying lowers or displaying does not follow change in the point of view or the line of sight possibly occurs.

Further, to acquire a photographed image with such a wide angle of view as to be incapable of being covered by the angle of view of one camera, images that are photographed by plural cameras and are different in the angle of view need to be connected. A technique of automatically connecting photographed images based on the positional relation among cameras, the individual angles of view, and so forth for this purpose is known. However, in the case of allowing the images connected in such a manner to be seen with free change in the line of sight, image distortion or discontinuity at a joint is visually recognized due to zooming up in some cases.

The present invention is made in view of such problems and an object thereof is to provide a technique of displaying a high-quality image by using an omnidirectional (360°) panorama photographed image.

### Solution to Problems

A certain aspect of the present invention relates to an image data output device. The image data output device is an image data output device that outputs data of an image used for displaying. The image data output device includes a partial image acquiring unit that acquires a plurality of partial images that configure the image, an output image generating unit that generates data of an image to be output from the partial images after deciding a connection position of the partial images, a map generating unit that generates map data that indicates the connection position, and a data output unit that associates the data of the image to be output with the map data and outputs the data of the image to be output and the map data.

Another aspect of the present invention relates to a content creation device. The content creation device includes a data acquiring unit that acquires data of an image obtained by connecting a plurality of partial images and map data that indicates a joint of the partial images, a content generating unit that refers to the map data and corrects the image regarding the joint and then employs the corrected image as data of content, and a data output unit that outputs the data of the content.

Still another aspect of the present invention relates to a content reproduction device. The content reproduction device includes a data acquiring unit that acquires data of a plurality of partial images that configure an image used for displaying and map data that indicates a connection position of the partial images, a display image generating unit that refers to the map data and connects the partial images in a region corresponding to a line of sight to generate a display image, and a data output unit that outputs the display image to a display device.

Yet another aspect of the present invention relates to an image data output method. The image data output method includes the followings: by an image data output device that outputs data of an image used for displaying, a step of acquiring a plurality of partial images that configure the image; a step of generating data of an image to be output from the partial images after deciding a connection position of the partial images; a step of generating map data that indicates the connection position; and a step of associating the data of the image to be output with the map data and outputting the data of the image to be output and the map data.

A further aspect of the present invention relates to a content creation method. The content creation method includes the followings: by a content creation device, a step of acquiring data of an image obtained by connecting a plurality of partial images and map data that indicates a joint of the partial images; a step of referring to the map data and correcting the image regarding the joint and then employing the corrected image as data of content; and a step of outputting the data of the content.

A still further aspect of the present invention relates to a content reproduction method. The content reproduction method includes the followings: by a content reproduction device, a step of acquiring data of a plurality of partial images that configure an image used for displaying and map data that indicates a connection position of the partial images; a step of referring to the map data and connecting the partial images in a region corresponding to a line of sight to generate a display image; and a step of outputting the display image to a display device.

What are obtained by translating any combinations of the above constituent elements and expressions of the present invention among a method, a device, a system, a computer program, a recording medium in which a computer program is recorded, and so forth are also effective as aspects of the present invention.

### Advantageous Effect of Invention

According to the present invention, a high-quality image can be displayed by using a wide-angle photographed image.

### BRIEF DESCRIPTION OF DRAWINGS

FIG. 1 is a diagram illustrating a configuration example of a content processing system to which the present embodiment can be applied.

FIG. 2 is a diagram illustrating an internal circuit configuration of an image data output device in the present embodiment.

FIG. 3 is a diagram depicting a configuration of functional blocks of the image data output device, a content creation device, and a content reproduction device in the present embodiment.

FIG. 4 is depicts diagrams exemplifying data output by the image data output device in order to properly correct a joint of partial images in the present embodiment.

FIG. 5 is a diagram exemplifying data output by the image data output device in the case in which moving images and still images are used as partial images in the present embodiment.

FIG. 6 is a diagram exemplifying data output by the image data output device when regions of moving images are made variable in the form of FIG. 5.

FIG. 7 is a diagram exemplifying data output by the image data output device in the case in which images different in the resolution are employed as partial images in the present embodiment.

FIG. 8 depicts diagrams illustrating a structure example of an imaging device for implementing the form described with FIG. 7.

FIG. 9 is a diagram exemplifying data output by the image data output device in the case in which additional images are caused to be included in partial images in the present embodiment.

FIG. 10 is a diagram exemplifying screens which the content reproduction device causes a display device to display by using the data illustrated in FIG. 9.

FIG. 11 is a diagram schematically illustrating correspondence between a photographic environment and photographed images in the case in which a stereo camera having two wide-angle cameras is employed as the imaging device in the present embodiment.

FIG. 12 is a diagram illustrating a configuration of functional blocks of an image data output device and a content reproduction device in the case in which the stereo camera is employed as the imaging device.

FIG. 13 is a diagram schematically illustrating procedure of processing in which the image data output device generates data to be output in the present embodiment.

### DESCRIPTION OF EMBODIMENT

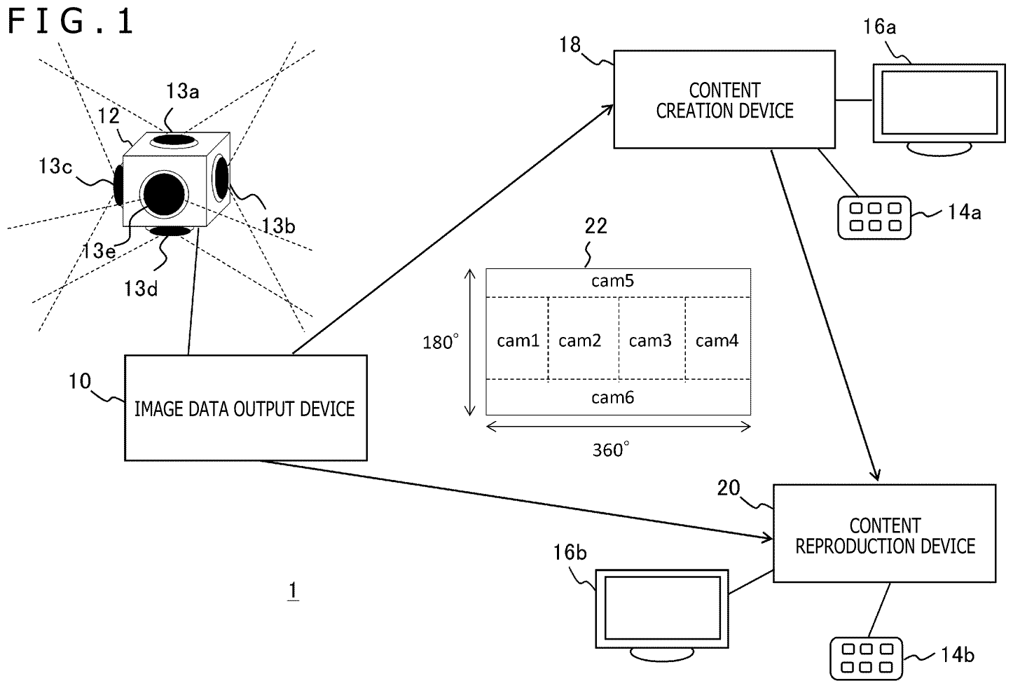

FIG. 1 illustrates a configuration example of a content processing system to which the present embodiment can be applied. A content processing system 1 includes an imaging device 12 that photographs a real space, an image data output device 10 that outputs data of an image that includes a photographed image and is used for displaying, a content creation device 18 that generates data of content including image displaying in which the output image is employed as an original image, and a content reproduction device 20 that carries out reproduction of content including image displaying with use of data of the original image or content.

To the content creation device 18, a display device 16a and an input device 14a used for creation of content by a content creator may be connected. To the content reproduction device 20, besides a display device 16b for viewing of an image by a content viewer, an input device 14b for carrying out operation to the content or the contents of displaying may be connected.

The image data output device 10, the content creation device 18, and the content reproduction device 20 establish communications through a wide area network such as the Internet or a local network such as a LAN (Local Area network). Alternatively, at least either of data provision from the image data output device 10 to the content creation device 18 and the content reproduction device 20 and data provision from the content creation device 18 to the content reproduction device 20 may be carried out through a recording medium.

The image data output device 10 and the imaging device 12 may be connected by a cable or may be wirelessly connected by a wireless LAN or the like. The content creation device 18 and the display device 16a and the input device 14a and the content reproduction device 20 and the display device 16b and the input device 14b may also be connected in either a wired or wireless manner. Alternatively, two or more devices in these devices may be integrally formed. For example, the imaging device 12 and the image data output device 10 may be combined to be formed as an imaging device or electronic equipment.

The display device 16b that displays an image reproduced by the content reproduction device 20 is not limited to a flat display and may be a wearable display such as a head-mounted display, a projector, and so forth. The content reproduction device 20, the display device 16b, and the input device 14b may be combined to be formed as a display device or an information processing device. As above, the appearance shape and the connection form of the various devices illustrated in the diagram are not limited. Further, in the case in which the content reproduction device 20 directly processes an original image from the image data output device 10 and generates a display image, the content creation device 18 does not have to be included in the system.

The imaging device 12 has plural cameras including plural lenses 13a, 13b, 13c, 13d, 13e . . . and imaging sensors such as CMOS (Complementary Metal Oxide Semiconductor) sensors corresponding to the respective lenses. Each camera photographs an image with an assigned angle of view. The mechanism that outputs an image obtained by light collection by each lens as two-dimensional luminance distribution is the same as a general camera. The photographed image may be either a still image or a moving image.

The image data output device 10 acquires pieces of data of photographed images output by the respective cameras and connects them to generate data of one original image. Here, the “original image” is the image that is the basis and is partly displayed or is displayed through being processed in some cases. For example, in the case in which an omnidirectional image is prepared and part thereof is displayed on a screen of a head-mounted display with a field of view corresponding to the line of sight of the viewer, this omnidirectional image is the original image.

In this case, for example, by introducing the imaging device 12 having four cameras having optical axes at intervals of 90° with respect to orientations in the horizontal direction and two cameras having optical axes vertically upward and vertically downward, images with angles of views obtained by dividing all orientations into sixths are photographed. Then, as in image data 22 in the diagram, the original image is generated by disposing a photographed image in the region corresponding to the angle of view of each camera and connecting the photographed images in an image plane in which the horizontal direction represents orientations of 360° and the vertical direction represents orientations of 180°. In the diagram, the images photographed by the six cameras are represented as “cam1” to “cam6,” individually.

The format of the image data 22 illustrated in the diagram is called equirectangular projection and is a general format used when an omnidirectional image is represented on a two-dimensional plane. However, the above description does not intend to limit the number of cameras and the format of data thereto, and the angle of view of the image obtained by the connection is also not particularly limited. Further, it is general that the joint of images is decided in consideration of the shape of an image that appears in the vicinity of this joint and so forth actually, and the joint does not necessarily become a straight line like those illustrated in the diagram. The image data 22 is subjected to compression encoding in a general format and thereafter is provided to the content creation device 18 through a network or recording medium.

In the case in which the imaging device 12 photographs a moving image, the image data output device 10 sequentially generates the image data 22 as an image frame in each time step and outputs the image data 22. The content creation device 18 generates content using the image data 22. The creation of content executed here may be all carried out by the content creation device 18 on the basis of a program prepared in advance or the like, or processing of at least part thereof may be manually carried out by a content creator.

For example, the content creator causes the display device 16a to display at least part of the image represented by the image data 22, and decides a region used for content and associates the image with a reproduction program or electronic game by using the input device 14a. The method for causing image data represented by the equirectangular projection to be displayed in various forms is a well-known technique. Alternatively, a moving image of the image data 22 may be edited by a general moving image editing application. The content creation device 18 itself may execute similar processing in accordance with a program created in advance or the like.

That is, the contents and purpose of the content created by the content creation device 18 are not limited as long as the image data 22 is used. Data of the content created in such a manner is provided to the content reproduction device 20 through a network or recording medium. The image data included in the content may have a configuration similar to that of the image data 22 or may be different in the data format or the angle of view. The image data may be what is obtained by executing some kind of processing on an image.

The content reproduction device 20 causes the display device 16b to display an image of content by executing processing of information provided as the content, and so forth, according to operation to the input device 14b by the content viewer, and so forth. Depending on the content, the point of view and the line of sight with respect to the display image may be changed according to operation to the input device 14b by the viewer. Alternatively, the point of view and the line of sight may be prescribed on the side of the content.

As one example, the content reproduction device 20 carries out mapping of the image data 22 on the inner surface of a celestial sphere centered at the content viewer who wears a head-mounted display and causes an image of the region in which the face of the content viewer is oriented to be displayed on a screen of the head-mounted display. When this is done, whichever direction the content viewer is oriented in, the content viewer can see the image world with a field of view corresponding to it and can obtain a feeling as if the content viewer entered this world.

Alternatively, a landscape or the like in the orientation of the movement destination may be allowed to be seen by employing a flat display as the display device 16b and moving a cursor displayed on it by the content viewer. When an image does not need to be edited or be associated with another piece of information, the content reproduction device 20 may acquire the image data 22 directly from the image data output device 10 and cause the display device 16b to display the whole or part thereof.

As above, the present embodiment is based on generating content and a display image by using the image data 22 obtained by connecting plural images independently acquired. Hereinafter, the photographed image before connection will be referred to as “partial image.” As described later, the partial image is not limited to a photographed image. Further, a region represented by a certain partial image may contain a region represented by another partial image. In this case, strictly the partial image of the latter is combined with or superimposed on the partial image of the former. Hereinafter, such a case will also be referred to as “connection” in some cases.

Further, it suffices that the image data output device 10 at least decides which position partial images are connected at. That is, depending on what kind of partial image is used, actual connection processing may be executed by the image data output device 10 itself or may be executed by the content creation device 18 or the content reproduction device 20. In either case, the image data output device 10 generates map data that indicates the connection position of partial images in the plane of the image after the connection and associates the map data with data of at least either of the image after the connection and the partial images before the connection to output them. Here, the “connection position” may be the position of the connection boundary (joint) or may be the position of the region occupied by the partial image.

In the case of connecting partial images photographed with different angles of view as in the form illustrated in FIG. 1, the image data output device 10 can make one image with continuity by detecting a correspondence point that appears in an overlapping manner at ends of partial images adjacent to each other and connecting the partial images in such a manner that an image is continuous at it. The image data 22 thus generated appears to be free from a sense of discomfort as a whole. However, if minute image distortion or a discontinuous part is left, it becomes conspicuous at the time of enlarged displaying and is visually recognized as a joint in some cases.

For this reason, when content that permits enlargement of an image is created, a desire to improve the quality of the content by correcting an image at the joint more strictly arises in the content creator. However, when the whole of a wide-angle image is seen, it is difficult for such trouble of the joint to be detected by the device or be noticed by the creator. When the image is displayed while being enlarged to such a degree that trouble of the joint can be detected or visually recognized, the possibility that the joint gets out of the field of view due to narrowing of the field of view becomes high, and it is difficult to find the place that should be corrected after all.

Thus, if the image data output device 10 outputs the map data that represents the connection position of partial images like the above-described one, enlargement of the image with an aim at the joint becomes possible on the side of the content creation device 18 and it becomes possible for the device or content creator to carry out processing and correction efficiently and without omission. The map data can also be used for purposes other than such processing and correction of an image. A specific example will be described later.

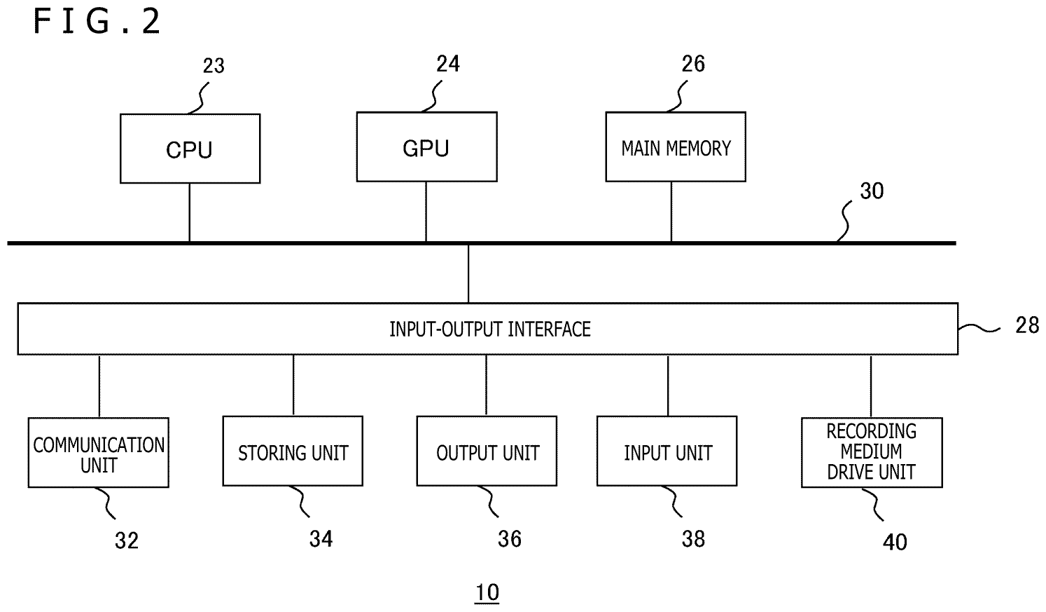

FIG. 2 illustrates an internal circuit configuration of the image data output device 10. The image data output device 10 includes a CPU (Central Processing Unit) 23, a GPU (Graphics Processing Unit) 124, and a main memory 26. These respective units are mutually connected through a bus 30. An input-output interface 28 is further connected to the bus 30. To the input-output interface 28, a communication unit 32 formed of peripheral equipment interfaces of USB (Universal Serial Bus), IEEE (Institute of Electrical and Electronics Engineers) 1394, and so forth and a network interface of a wired or wireless LAN, a storing unit 34 of hard disk drive, non-volatile memory, and so forth, an output unit 36 that outputs data to external equipment, an input unit 38 that inputs image data from the imaging device 12 and data of photographing clock time, position, photographing orientation, and so forth, and a recording medium drive unit 40 that drives a removable recording medium such as a magnetic disc, optical disc, or semiconductor memory are connected.

The CPU 23 controls the whole of the image data output device 10 by executing an operating system stored in the storing unit 34. Further, the CPU 23 executes various programs that are read out from a removable recording medium to be loaded into the main memory 26 or are downloaded through the communication unit 32. The GPU 24 has functions of a geometry engine and functions of a rendering processor and executes rendering processing in accordance with a rendering command from the CPU 23 to carry out output to the output unit 36. The main memory 26 is configured by a RAM (Random Access Memory) and stores program and data necessary for processing. The internal circuit configurations of the content creation device 18 and the content reproduction device 20 may also be similar.

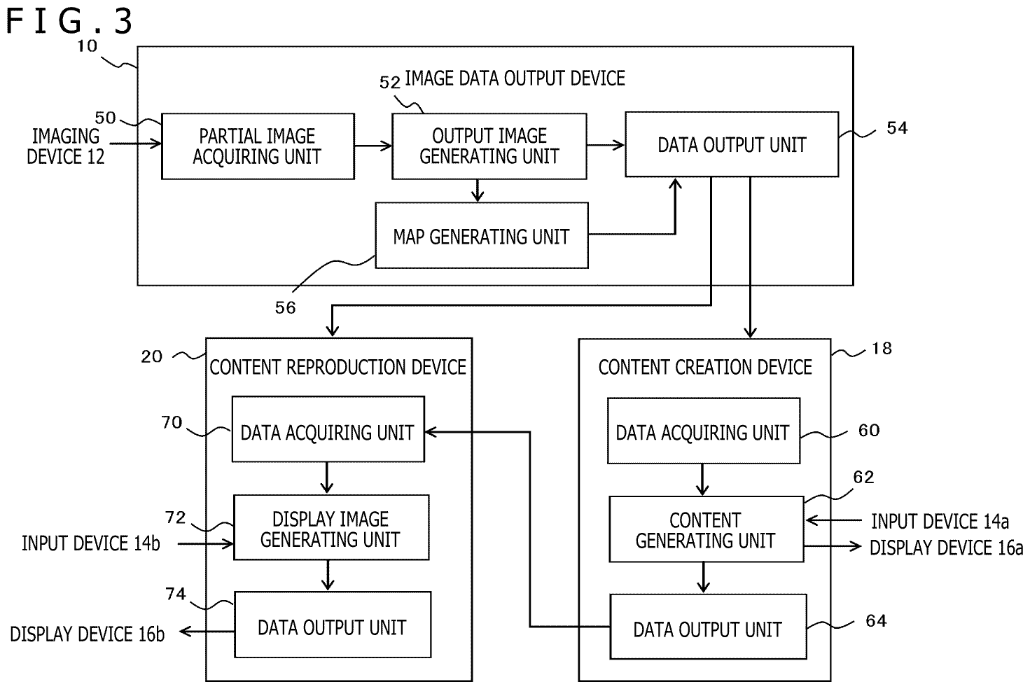

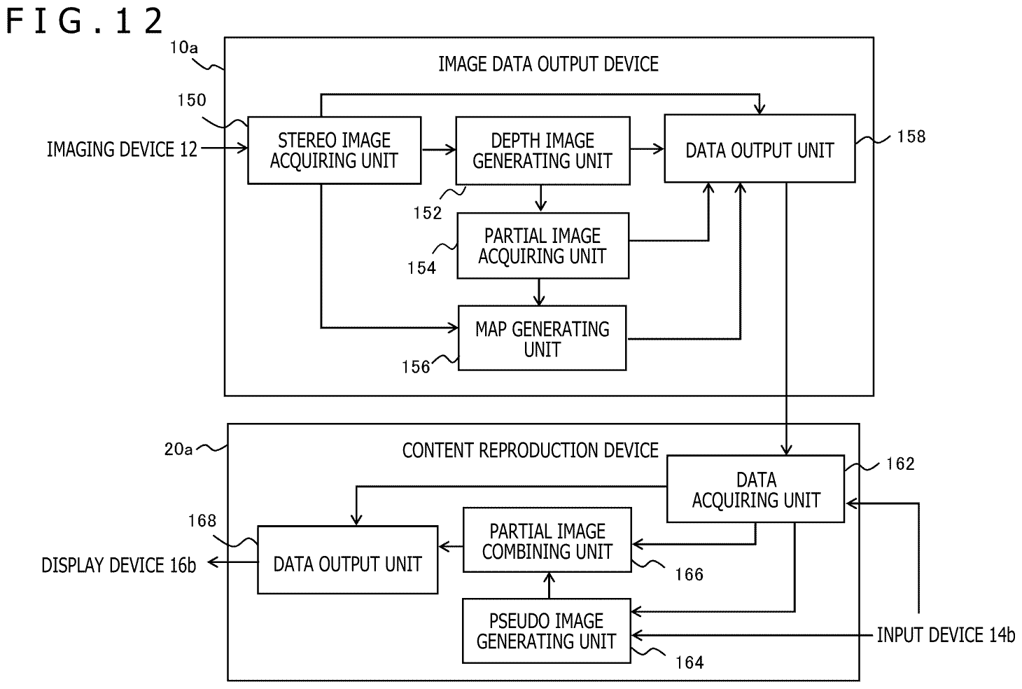

FIG. 3 illustrates a configuration of functional blocks of the image data output device 10, the content creation device 18, and the content reproduction device 20. The respective functional blocks illustrated in this diagram and FIG. 12 to be described later can be implemented by various circuits illustrated in FIG. 2 in terms of hardware and, in terms of software, are implemented by a program that is loaded into the main memory from a recording medium and exerts functions such as an image analysis function, an information processing function, an image rendering function, and a data input-output function. Therefore, it is understood by those skilled in the art that these functional blocks can be implemented in various forms by only hardware or only software or a combination of them, and the functional blocks are not limited to any.

The image data output device 10 includes a partial image acquiring unit 50 that acquires data of partial images from the imaging device 12, an output image generating unit 52 that generates data of the image that should be output, such as an image obtained by connecting partial images and a partial image itself, a map generating unit 56 that generates map data relating to connection, and a data output unit 54 that outputs the image data and the map data. The partial image acquiring unit 50 is implemented by the input unit 38, the CPU 23, the main memory 26, and so forth in FIG. 2 and acquires plural photographed images that are photographed by plural cameras and are different in the field of view from the imaging device 12.

In the form in which the field of view of the camera that configures the imaging device 12 is changed as described later, the partial image acquiring unit 50 acquires data that indicates the angle of the optical axis of the camera together with data of the photographed image. Further, in the case in which an image other than the photographed image, such as character information or a figure, is used as part of a partial image, the partial image acquiring unit 50 may internally generate this image in accordance with instruction input by a user, or the like.

The output image generating unit 52 is implemented by the CPU 23, the GPU 24, the main memory 26, and so forth in FIG. 2. The output image generating unit 52 decides the connection position of partial images and then generates data of the image that should be output from the partial images. For example, the output image generating unit 52 connects partial images to generate one piece of image data. Due to the angle of view of each camera (disposing of the lens) in the imaging device 12, which range in the image plane after connection the field of view of each camera corresponds to is known in advance. The output image generating unit 52 generates one piece of image data like the image data 22 in FIG. 1, for example, by deciding the connection position and carrying out connection on the basis of the relevant information, the correspondence point of an image that appears in an overlapping manner as described above, and so forth. Further, the output image generating unit 52 may make the joint inconspicuous by executing blending processing for the boundary part between partial images, or the like.

Alternatively, the output image generating unit 52 may only decide the partial images that should be connected and the connection position thereof, on the premise that the content creation device 18 or the content reproduction device 20 executes connection processing of the partial images. The map generating unit 56 is implemented by the CPU 23, the GPU 24, the main memory 26, and so forth in FIG. 2 and generates map data that indicates the connection position of partial images. The map data indicates the joint of partial images in the plane of the image after connection of the partial images. As described above, in the case of combining a partial region of a certain image with another image, the map data indicates the boundary thereof as the joint. Further, in the map data, each region having a joint as a boundary may be associated with the corresponding partial image. A specific example will be described later.

The data output unit 54 is implemented by the CPU 23, the main memory 26, the communication unit 32, and so forth in FIG. 2. The data output unit 54 associates data of at least either of partial images and an image obtained by connecting them with map data and carries out compression encoding as appropriate to output the resulting data to the content creation device 18 or the content reproduction device 20. Alternatively, the data output unit 54 may include the recording medium drive unit 40 and associate image data with map data to store them in a recording medium. In the case in which the image data is a moving image, at the timing when information indicated by the map data changes, the data output unit 54 outputs the image data in association with an image frame at the time.

The content creation device 18 includes a data acquiring unit 60 that acquires image data and map data, a content generating unit 62 that generates data of content by using the acquired data, and a data output unit 64 that outputs the data of the content. The data acquiring unit 60 is implemented by the communication unit 32, the CPU 23, the main memory 26, and so forth in FIG. 2 and acquires image data and map data output by the image data output device 10. Alternatively, as described above, the data acquiring unit 60 may include the recording medium drive unit 40 and read out the image data and the map data from a recording medium. The data acquiring unit 60 decodes and expands these pieces of data according to need.

The content generating unit 62 is implemented by the CPU 23, the GPU 24, the main memory 26, and so forth in FIG. 2 and generates data of content including image displaying by using the image data provided from the image data output device 10. The created content is an electronic game, a video for viewing, an electronic map, a website, and so forth and the kind and the purpose thereof are not limited. The image to be included in the content may be the whole of image data acquired from the image data output device 10 or may be part thereof. The content generating unit 62 may automatically generate information that prescribes such selection of the image and how the image is displayed, or the content creator may manually generate at least part of the information.

In the latter case, the content generating unit 62 causes the display device 16a to display the image and accepts correction and editing of the image input by the content creator through the input device 14a. In either case, the content generating unit 62 refers to map data and generates the image to be included in content. For example, the content generating unit 62 executes detection processing of image distortion or a discontinuous part regarding a predetermined region including a joint in image data resulting from connecting by the image data output device 10, and instructs the content creator to correct it or executes predetermined processing by itself.

Alternatively, the content generating unit 62 connects partial images provided from the image data output device 10 based on the map data. Further, the content generating unit 62 may newly generate a partial image. For example, an image that represents additional information (hereinafter, referred to as “additional image”) such as character information of explanation of a subject, subtitles, and so forth and a figure desired to be added to an image may be generated based on instruction input by the content creator, or the like. In this case, similarly to the map generating unit 56 of the image data output device 10, the content generating unit 62 generates map data that represents the position at which the additional image is combined (connected) in the plane of the image used for displaying and employs the map data as part of content data together with data of the additional image.

The content generating unit 62 may cause at least part of partial images provided from the image data output device 10 to be included in data of content together with map data without connection. Further, in the case in which the image data output device 10 provides an omnidirectional image photographed from plural points of view, the content generating unit 62 may acquire a three-dimensional model of the photographic place from this photographed image and the positional relation among the respective points of view and cause the three-dimensional model to be included in the content data. This technique is generally known as SfM (Structure from Motion). However, in the case in which processing of correcting discontinuity of a boundary, such as blending, has been executed for the connecting part of partial images, estimation of the distance of a subject whose image appears at the connecting part is difficult if nothing is done. Thus, the content generating unit 62 may clip the partial images before the correction on the basis of map data and carry out three-dimensional modeling of the subject regarding each of these partial images.

The data output unit 64 is implemented by the CPU 23, the main memory 26, the communication unit 32, and so forth in FIG. 2 and carries out compression encoding of data of content generated by the content generating unit 62 as appropriate to output the resulting data to the content reproduction device 20. Alternatively, the data output unit 64 may include the recording medium drive unit 40 and store the data of the content in a recording medium.

The content reproduction device 20 includes a data acquiring unit 70 that acquires image data and map data or data of content, a display image generating unit 72 that generates a display image by using the acquired data, and a data output unit 74 that outputs data of the display image. The data acquiring unit 70 is implemented by the communication unit 32, the CPU 23, the main memory 26, and so forth in FIG. 2 and acquires image data and map data output by the image data output device 10 or data of content output by the content creation device 18. Alternatively, the data acquiring unit 70 may include the recording medium drive unit 40 and read out these pieces of data from a recording medium. The data acquiring unit 70 decodes and expands these pieces of data according to need.

The display image generating unit 72 is implemented by the CPU 23, the GPU 24, the main memory 26, and so forth in FIG. 2 and generates the image that should be displayed by the display device 16b by using the image data provided from the image data output device 10 or the data of the content generated by the content creation device 18. Basically the display image generating unit 72 changes the point of view and the line of sight with respect to an image obtained by connecting partial images according to operation by the content viewer through the input device 14b and generates an image of the region corresponding to it as a display image. Information processing of an electronic game or the like may be first executed through operation by the content viewer, and the point of view and the line of sight may be changed as the result thereof.

A general technique can be applied to the method for displaying an image with the field of view corresponding to the point of view and the line of sight in a wide-angle image. Further, the display image generating unit 72 may complete the image as the basis of displaying through referring to map data and connecting and updating partial images in the region corresponding to the line of sight. Further, as described later, the display image generating unit 72 may execute processing of noise addition or the like for part of the display image and switch the partial images of the connection target in accordance with an instruction by the content viewer. The data output unit 74 is implemented by the CPU 23, the main memory 26, the output unit 36, and so forth in FIG. 2 and outputs data of the display image generated in such a manner to the display device 16b. The data output unit 74 may also output data of sound according to need besides the display image.

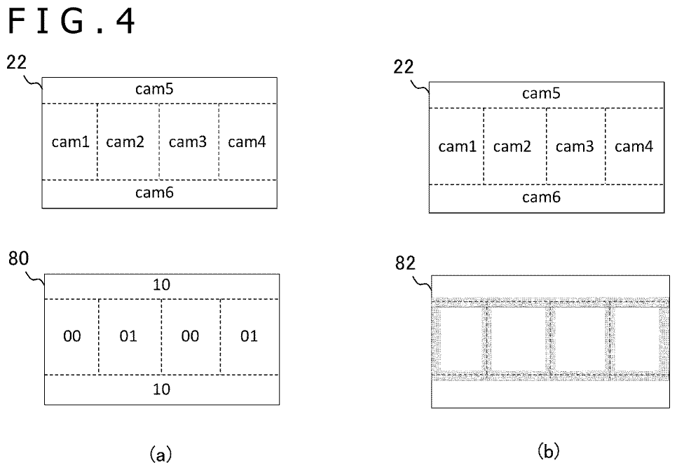

FIG. 4 exemplifies data output by the image data output device 10 in order to properly correct the joint of partial images. (a) illustrates, as an output target, the image data 22 and map data 80 that represents joints thereof by change in the pixel value. The image data 22 indicates data of an image obtained by connecting images photographed by six cameras by the equirectangular projection as illustrated in FIG. 1. Regions “cam1” to “cam6” marked out by dotted lines illustrate the partial images photographed by the respective cameras. However, the partial image may be part of the image photographed by each camera and each region can have various shapes depending on an actual image.

The map data 80 is data of an image that represents the joints of such partial images by the difference in the pixel value. In this example, the pixel values of the regions of the partial images of “cam1,” “cam2,” “cam3,” “cam4,” “cam5,” and “cam6” are set to 2-bit values of “00,” “01,” “00,” “01,” “10,” and “10,” respectively. When the pixel values of partial images adjacent to each other are made different as above, it is found that the joint exists at the part across which there is the difference in the pixel value. The number of bits of the pixel value and the assignment are various depending on the number and arrangement of connected partial images.

(b) illustrates, as an output target, the image data 22 and map data 82 that represents lines of joints thereof. The image data 22 has the same configuration as (a). The map data 82 is data of an image that represents the lines themselves of the joints. For example, the map data 82 is created as a 1-bit white-black image in which the value of the pixels that represent these lines is set to 1 whereas the value of the other pixels is set to 0, or the like. The line that represents the joint may have a width corresponding to a predetermined number of pixels including the actual joint or may have a width of one pixel in contact with the inside or outside of the joint.

Alternatively, the part of these lines may be highlighted in the image data 22 itself, on the premise that the image is corrected by the content creation device 18 or the like. For example, the pixel value may be set larger by a predetermined ratio or the pixel color may be replaced by another color. Alternatively, in order to allow discrimination of each region of the map data, a semitransparent filling region may be superimposed, and the resulting image may be output. Further, in the case in which the joints are straight lines as illustrated in the diagram, the coordinates of the intersections of the straight lines may be output instead of the map data.

The content creation device 18 that has acquired such data carries out enlargement with a focus on, in the image data 22, the part across which there is a difference in the pixel value in the map data 80 or the part different from the surroundings in the pixel value in the map data 82. In addition, the content creation device 18 detects image distortion and discontinuity and carries out processing and correction by an existing filtering technique such as smoothing. Alternatively, the display device 16a is caused to display an enlarged image to allow the content creator to carry out processing and correction. This enlargement and correction is repeatedly carried out regarding all regions having a possibility of being displayed as content. This can generate a high-quality image efficiently and without omission. The content reproduction device 20 may execute similar processing for the display region.

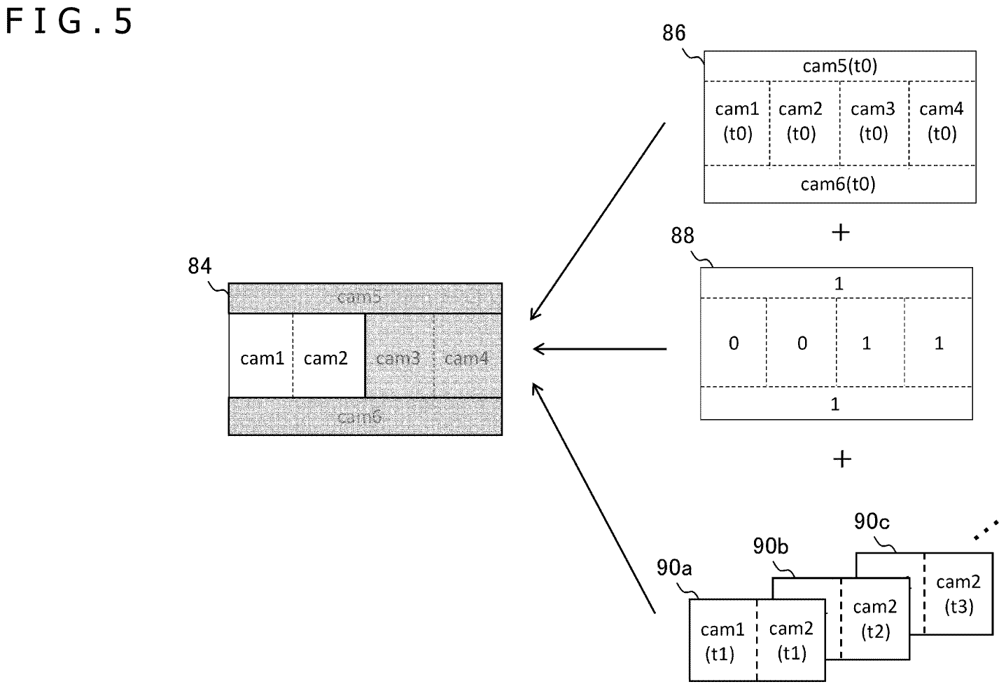

FIG. 5 exemplifies data output by the image data output device 10 in the case in which moving images and still images are employed as partial images. In the case of attempting to display a moving image with such a wide angle as to be represented through coupling images photographed by plural cameras with a resolution equivalent to that of a moving image with a general angle of view, data transmission and the storage area inside and outside each device are compressed due to increase in the data size, and the load of processing also becomes larger. Meanwhile, it is considered that many regions free from motion of an image are included in a wide field of view. Thus, by leaving only images that involve motion of an image as moving images in partial images obtained by photographing of a moving image by plural cameras and replacing the other partial images by still images, the data size can be reduced with the minimum influence on the appearance.

In the example illustrated in the diagram, in image data 84 obtained by connecting images photographed by six cameras similarly to the image data 22 in FIG. 1, the regions “cam1” and “cam2” are set as moving images, and the other regions “cam3” to “cam6” are set as still images. In this case, pieces of image data output from the image data output device 10 are image data 86 obtained by connecting all partial images at a first clock time t0, map data 88 for discrimination between the regions of moving images and the regions of still images, and pieces of image data 90a, 90b, 90c, . . . of the regions of moving images at subsequent clock times t1, t2, t3, . . . .

In the map data 88 in the example illustrated in the diagram, the pixel value of the regions that represent moving images in the image plane is set to “0,” and the pixel value of the regions that represent still images is set to “1.” However, by combining the information that represents joints, explained with FIG. 4, correction of the joints may be enabled. For example, in the case of representing joints by 2-bit pixel values as in (a) of FIG. 4, the pixel values may be combined with discrimination of moving image/still image to make 3-bit pixel values.

The output image generating unit 52 of the image data output device 10 identifies the partial image that may be set to a still image by taking the inter-frame difference of each moving image photographed by each camera of the imaging device 12. For example, the region corresponding to the moving image in which the total of the difference in the pixel value is equal to or smaller than a predetermined value between frames over the whole moving image is set to a still image. In the case in which the composition is fixed at a certain degree, such as the case in which a subject moves only at part of an indoor space free from motion or a vast space, regions treated as moving images and regions treated as still images may be set in advance. Then, part of partial images acquired as moving images is replaced by a still image.

The content creation device 18 or the content reproduction device 20 refers to the map data 88 and sequentially replaces images of the regions of the moving images in the image data 86 of the clock time t0 by frames of moving images of the subsequent clock times t1, t2, t3, . . . . This can generate data of a moving image obtained by combining the still images and the moving images. The content creation device 18 employs the whole or part of such a moving image as image data of content. Further, the content reproduction device 20 causes the display device 16b to display the whole or part of such a moving image.

In the case in which the display device 16b doubles as the image data output device 10, such as the case of a head-mounted display including the imaging device 12 and the image data output device 10, partial images that may be set to still images may be saved in a memory inside the image data output device 10. In this case, only data of the regions of moving images is transmitted from the image data output device 10 to the content creation device 18 or the content reproduction device 20 and necessary processing is executed. Then, the image data output device 10 combines the data with still images immediately before displaying. This can suppress the amount of data that should be transmitted.

In the case in which information on joints is included in map data as described above, the content creation device 18 may correct the joints of partial images to make the joints be less likely to be visually recognized as described with FIG. 4. Further, when a region of part of a moving image is set to a still image, only this region appears to be conspicuous conversely in some cases because noise peculiar to a moving image (block noise that changes over time, and so forth) does not exist at all. Thus, the content generating unit 62 of the content creation device 18 or the display image generating unit 72 of the content reproduction device 20 may superimpose pseudo-noise on the region of the still image in the frames of the generated moving image to thereby prevent the occurrence of a sense of discomfort. A general technique can be used for the noise superposition itself.

The regions of moving images are clearly indicated by the map data 88. In addition, the other regions are replaced by still images. This can suppress the data size even with a wide-angle image like an omnidirectional image and save the necessary transmission band and storage area. Further, it suffices that only a partial region is updated in the content creation device 18 or the content reproduction device 20, and therefore, the load of the processing is reduced. Thus, it is also possible to enhance the resolution of the output image at a certain degree. As a result, a high-resolution moving image can be allowed to be viewed without delay even when it is a wide-angle image.

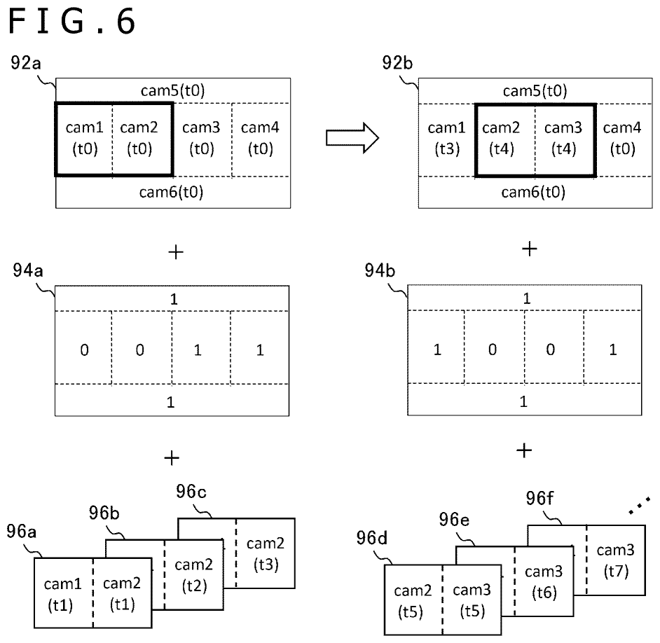

FIG. 6 exemplifies data output by the image data output device 10 when regions of moving images are made variable in the form of FIG. 5. In this form, targets replaced by still images in partial images acquired as moving images are switched according to movement of a region involving motion. In this case, first, similarly to the form illustrated in FIG. 5, image data 92a obtained by connecting all partial images at the first clock time t0, map data 94a for discrimination between the regions of moving images and the regions of still images, and pieces of image data 96a, 96b, and 96c of the regions of moving images at the subsequent clock times t1, t2, and t3 are output.

Here, suppose that regions involving motion move from regions of a heavy-line frame in the image data 92a to regions of a heavy-line frame in image data 92b. The regions involving motion can be detected based on the inter-frame difference of each moving image that configures the partial image as described above. In this case, the image data output device 10 outputs the image data 92b of the whole of the image plane in which the frames of the latest partial images, i.e., the frames of the partial images of a clock time t4, of the regions of the movement destination are included, new map data 94b for discrimination between the regions of moving images and the regions of still images, and pieces of image data 96d, 96e, 96f, . . . of the regions of moving images at subsequent clock times t5, t6, t7, . . . .

However, the regions that change in the period from the clock time t3 to the clock time t4 are nothing less than the regions of moving images in the plane of the image data 92b. Therefore, depending on the case, only the frames of the partial images of the clock time t4 may be output without outputting the image data 92b. Further, the size of the region of the moving image may change. Operation of the content creation device 18 and the content reproduction device 20 is basically the same as that described with FIG. 5. However, the regions to which moving images are connected are changed in the image frame with which the new map data 94b is associated. Due to this, even when regions involving motion move, a moving image can be expressed through connecting still images and moving images, and the size of the data as the target of transmission and processing can be reduced with the minimum influence on the appearance.

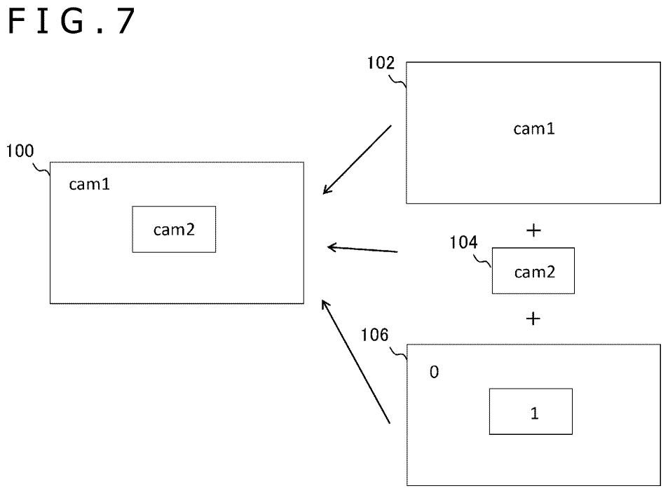

In the forms illustrated in FIGS. 5 and 6, the data size is reduced by allowing connection of moving images and still images in the case in which the motion of an image is restrictive in a wide field of view. Further, in a wide-angle image, a region at which a viewer gazes is also likely to be restrictive. It is also conceivable that the characteristic is utilized to reduce the data size through connecting images different in the resolution. FIG. 7 exemplifies data output by the image data output device 10 in the case in which images different in the resolution are employed as partial images.

In this example, to a partial region “cam2” of an overall region “cam1” that is photographed by a wide-angle camera and is used for displaying in image data 100, an image photographed with a narrower angle of view and a higher resolution than it is connected. In this case, pieces of data output by the image data output device 10 are image data 102 photographed by the wide-angle camera, image data 104 photographed by a camera with a narrow angle of view and a high resolution, and map data 106 for discrimination between regions of both. The wide-angle image and the narrow-angle image may both be a moving image or still image, or either one may be a still image and the other may be a moving image.

In the example illustrated in the diagram, in the map data 106, the pixel value of the region of the wide-angle image in the image plane is set to “0,” and the pixel value of the region of the narrow-angle image is set to “1.” The region represented with the high resolution may be only one region as illustrated in the diagram or may be plural regions photographed by plural cameras. In this case, information for discrimination of images associated with the respective regions may be incorporated as the pixel value of the map data 106. Further, the region represented with the high resolution may be fixed or may be made variable.

Further, in the case of connecting partial images as illustrated in FIG. 4 to generate the wide-angle image data 102, the joint thereof may also be represented on the map data 106 and thereby be allowed to be corrected by the content creation device 18 or the like. Further, as illustrated in FIGS. 5 and 6, part of the wide-angle image data 102 may be set to a moving image, the other part may be set to a still image, and discrimination thereof may also be represented by the map data 106.

The content creation device 18 or the content reproduction device 20 refers to the map data 106 and connects the image data 104 to the region that should be represented with the high resolution in the wide-angle image data 102. In this case, processing of replacing the low-resolution image in the relevant region of the image data 102 by the high-resolution image of the image data 104 is executed. Due to this, while image displaying with a wide field of view is permitted, a region having a high possibility of attracting a gaze can be represented in detail with the high resolution.

The content creation device 18 employs the whole or part of such an image as image data of content. Further, the content reproduction device 20 causes the display device 16b to display the whole or part of such an image. In the case in which information on joints is included in map data as described above, the content creation device 18 may correct the joints of partial images to make the joints be less likely to be visually recognized as described with FIG. 4.

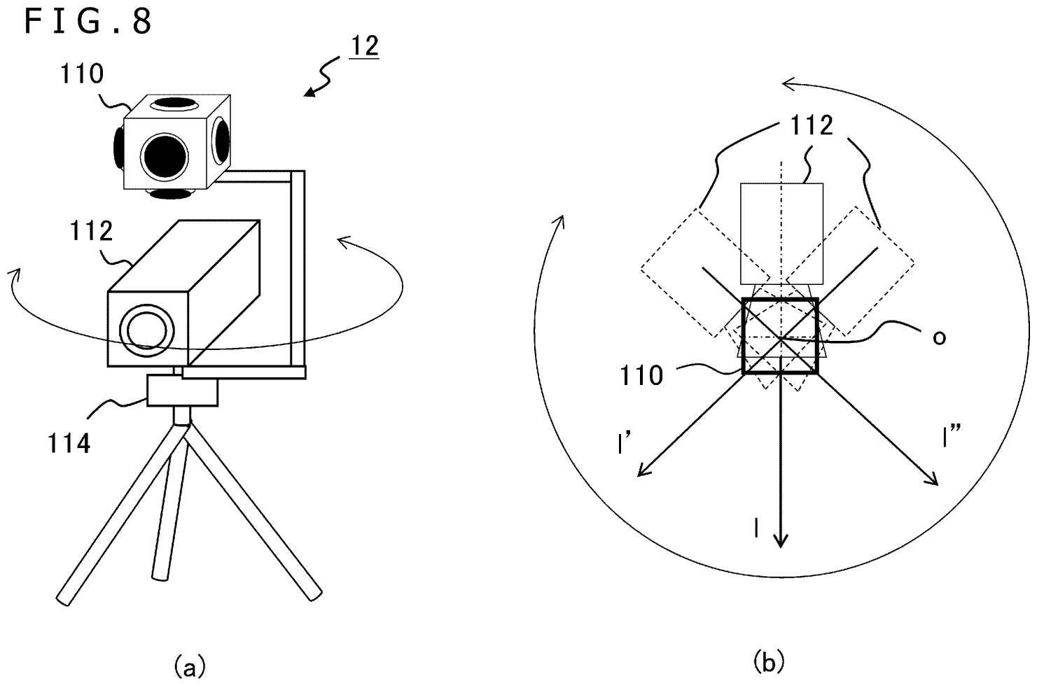

FIG. 8 illustrates a structure example of the imaging device 12 for implementing the form described with FIG. 7. As illustrated in (a), the imaging device 12 includes a camera 110 for the wide-angle image and a camera 112 for the high-resolution image. The imaging device 12 further includes an angle-of-view measurement part 114 in the case in which the region of the high resolution is made variable. The camera 110 for the wide-angle image is a camera that photographs an omnidirectional image, for example, and may be further composed of plural cameras as described with FIG. 1. The camera 112 for the high-resolution image is a camera of a general angle of view, for example, and photographs an image with a higher resolution than the camera 110 for the wide-angle image.

In the case in which the region of the high resolution is made variable, in response to pan operation of the camera 112 for the high-resolution image, the angle-of-view measurement part 114 measures the angle thereof and supplies the angle to the image data output device 10 together with data of a photographed image. The orientation of the camera 110 for the wide-angle image is fixed. For example, in the case in which the camera 112 for the high-resolution image carries out photographing with the optical axis set to directions of 180° in the horizontal direction and directions of 90° in the vertical direction in the omnidirectional image photographed by the camera 110 for the wide-angle image, the narrow-angle image data 104 is associated with the very center of the wide-angle image data 102 as illustrated in FIG. 7.

The image data output device 10 deems this state as the basis and identifies the region to which the narrow-angle image data 104 should be connected in the plane of the wide-angle image data 102 on the basis of angle change of the pan direction of the camera 112 for the high-resolution image, to generate the map data 106. That is, when the camera 112 for the high-resolution image is caused to carry out pan operation, the map data 106 also becomes a moving image together with the narrow-angle image data 104. Further, in the case in which a moving image is also employed as the image data 102, the image data output device 10 outputs the three pieces of data illustrated in the diagram in time steps of the moving image. The pan operation itself may be carried out by the photographer according to the situation.

In such a form, it is desirable to form the imaging device 12 in such a manner that, as illustrated in a bird's-eye view of (b), a rotation center o of the pan operation of the camera 112 for the high-resolution image, i.e., the fixed point of variable optical axes 1, 1′, and 1″, is made to correspond with the optical center of the camera 110 for the wide-angle image. Due to this, when the wide-angle image data 102 is represented by the equirectangular projection, the angle of the pan direction represents, i.e., the position in the horizontal direction at which the narrow-angle image should be connected.

For example, in the case of providing a moving image of a concert, the viewer can enjoy a feeling of presence by causing the viewer to see the state of the whole of the venue including the audience. However, the data size of the content becomes enormous if high-resolution data is employed for all of the moving image. Due to this, the transmission band and the storage area become tight. In addition, the load of processing of decoding and so forth increases, which possibly causes latency. When the whole is set to a low resolution, the image quality appears to be lower than a general moving image. Even if the region in which the resolution is set high is changed on the side of the content reproduction device 20 according to the line of sight of the viewer, following the change in the line of sight is difficult due to the load of processing in some cases.

Thus, as described above, the map data 106 is generated and output on the premise that the whole is photographed with a low resolution whereas a region to which the viewer is highly likely to pay attention, such as a main performer, is photographed with a narrow angle and a high resolution and is combined later. Due to this, the data size is suppressed as a whole, and content that allows an image with a feeling of presence to be viewed without delay can be implemented while the influence on the appearance is suppressed to the minimum.

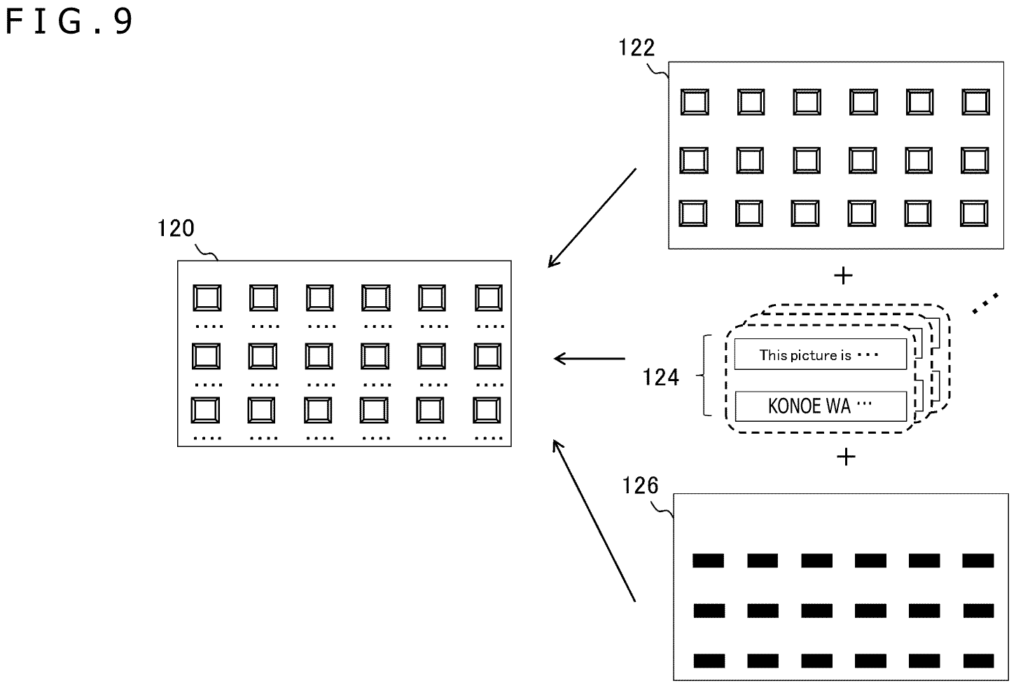

An additional image may be connected instead of the image with the narrow angle and the high resolution in the form illustrated in FIG. 7. FIG. 9 exemplifies data output by the image data output device 10 in the case in which additional images are caused to be included in partial images. In this example, a wide-angle image is represented in the whole of image data 120 and sentences to explain a large number of subjects are indicated as additional information. In this case, pieces of data output from the image data output device 10 are image data 122 photographed by a wide-angle camera, additional image data 124, and map data 126 that indicates regions in which the additional information should be represented.

In this example, as the additional image data 124, plural images in which explanatory sentences of the respective subjects are represented by different languages such as English and Japanese are prepared in such a manner as to be switchable. The contents represented by the additional information are not limited to the explanatory sentence and are enough when being necessary character information such as subtitles of voice of persons that appear in a moving image. Further, the additional information is not limited to characters and may be a figure or image. The wide-angle image data 122 that serves as the base may be either a still image or moving image. In the map data 126 illustrated in the diagram, the region of the wide-angle image in the image plane is set to white whereas the regions of the additional images are set to black. However, actually the latter regions are given a pixel value that indicates identification information of the corresponding additional image in the additional image data 124. In the case of switching plural languages, plural additional images are associated with one region.

Further, also in this form, in the case of connecting partial images as illustrated in FIG. 4 to generate the wide-angle image data 122, the joints thereof may be represented on the map data 126 and be allowed to be corrected by the content creation device 18 or the like. Further, as illustrated in FIGS. 5 and 6, part of the wide-angle image data 122 may be set to a moving image, the other part may be set to a still image, and discrimination thereof may also be represented by the map data 126. Alternatively, part of the wide-angle image data 122 may be set to an image with a high resolution, and discrimination thereof may also be represented by the map data 126.

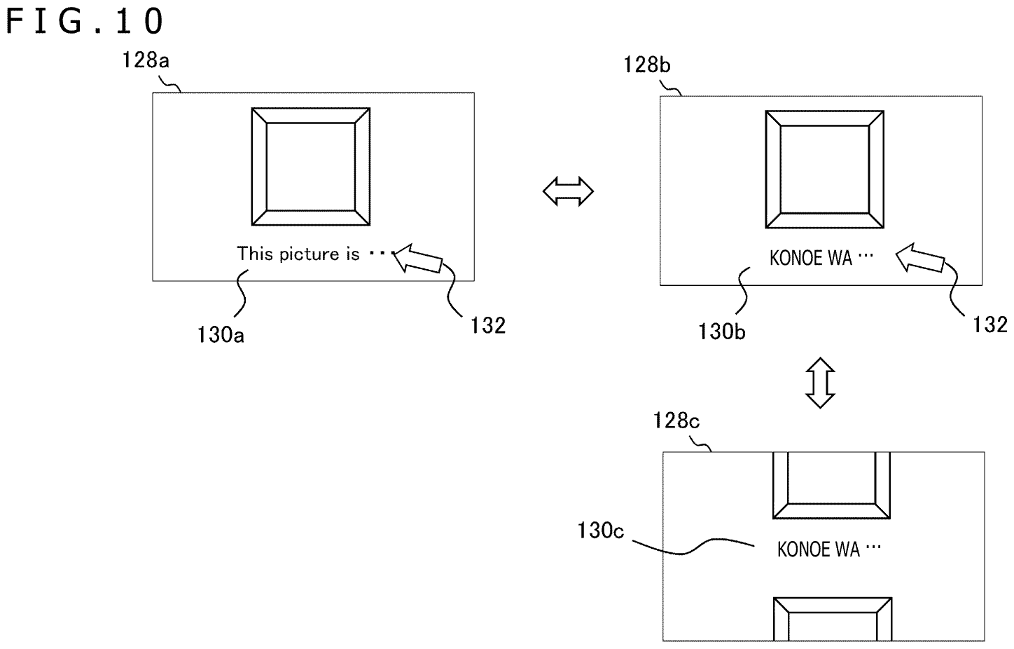

FIG. 10 exemplifies screens which the content reproduction device 20 causes the display device 16b to display by using the data illustrated in FIG. 9. The content reproduction device 20 first identifies a region corresponding to the field of view based on operation by a viewer in the wide-angle image data 122. Then, the content reproduction device 20 refers to the map data 126 and acquires the region to which an additional image should be connected in this region and the identification information of the additional image that should be connected thereto. Then, as the result of connecting and displaying both, for example, as in a screen 128a, in an image in which a certain subject is zoomed up, an English sentence 130a that explains this subject is displayed. The language may be fixedly set in advance or may be automatically selected from the profile or the like of the viewer.

The content reproduction device 20 further displays a cursor 132 for specifying the additional image in the screen 128a. When the content viewer sets the cursor 132 on the additional image and makes a choice through pressing down an Enter button of the input device 14b, or the like, the content reproduction device 20 refers to the map data 126 again and replaces the additional image that should be displayed there by an additional image of another language. In the example illustrated in the diagram, a Japanese sentence 130b is displayed. In the case in which three or more languages are prepared, a list from which the viewer can make a choice may be additionally displayed, or the language may be switched in order every time the Enter button is pressed down. Further, the operation means for specifying the additional image and switching it to another language is not limited to the above-described one. For example, switching through touching a touch panel disposed to cover the display screen, or the like, may be employed.

In a general display form in which the angle of view of displaying corresponds with that of the original image given as the display target, a main subject exists around the center of the screen in many cases and therefore an explanatory sentence or subtitle rarely becomes an obstacle even when being fixedly displayed at a lower part of the screen or the like. On the other hand, in a form in which a wide-angle image is seen while the line of sight is freely changed, the flexibility of the position of the main subject relative to the screen is high. For this reason, when the display position of an explanatory sentence or subtitle is fixed, possibly the explanatory sentence or subtitle overlaps with the main subject and becomes difficult to see.

Further, in the case in which an explanatory sentence or the like is included in the original image data 122, it is also conceivable that, due to further addition of an image in which it is represented by another language, character strings are displayed in an overlapping manner and are unreadable. Thus, as described with FIGS. 9 and 10, the additional information is made as different data from the original image, and the position at which the additional information should be displayed is associated with the original image as the map data. This can display the additional information at a proper position even when the line of sight is freely changed.

For example, as illustrated in a screen 128c in the diagram, even when the line of sight is moved from the screen 128b, an explanatory sentence 130c follows the motion and therefore does not become an obstacle to another subject. In addition, it also does not become unclear which subject the explanatory sentence 130c corresponds to as the additional information. Meanwhile, switching to another language can be easily carried out through operation by the viewer. The additional information is variously conceivable as described above. Therefore, the attribute to be switched is not limited to the language and may be a sentence itself or the color, shape, or the like of a figure. Further, displaying/non-displaying of the additional information may be switched.

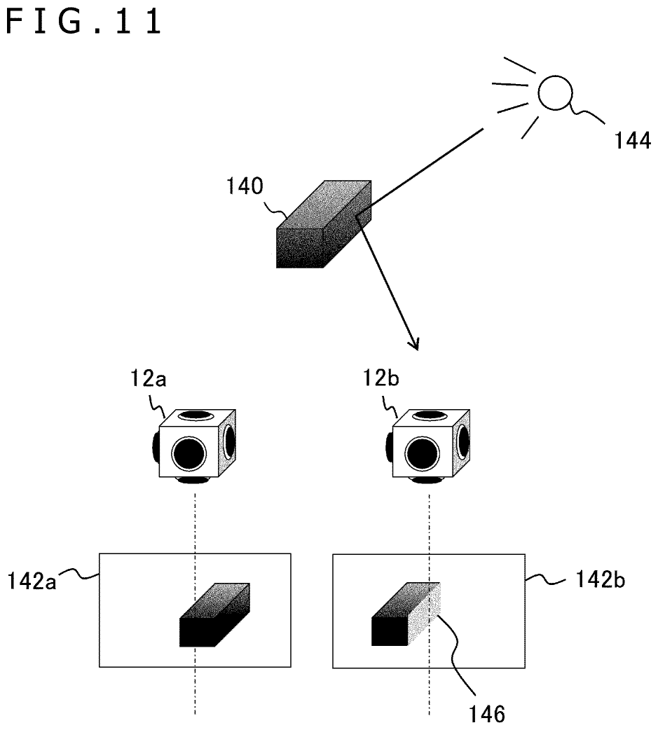

FIG. 11 schematically illustrates correspondence between a photographic environment and photographed images in the case in which a stereo camera having two wide-angle cameras is employed as the imaging device 12. Specifically, cameras 12a and 12b photograph a surrounding object (for example, subject 140) from left and right points of view with the intermediary of a known interval. The individual cameras 12a and 12b further include plural cameras that carry out photographing with different angles of view similarly to the imaging device 12 in FIG. 1 and thereby photograph a wide-angle image such as an omnidirectional image. For example, the distance between the cameras 12a and 12b is made to correspond to the distance between both eyes of the human, and an image photographed by each camera is caused to be seen by both eyes of a content viewer by a head-mounted display or the like. This allows the viewer to stereoscopically view the image and obtain a higher sense of immersion.

In such a form, wide-angle images are two images 140a and 140b. Due to this, the data size becomes twice compared with the case of one image. The data size is suppressed by decimating data and halving the size in the vertical direction or the horizontal direction. However, the quality of displaying lowers due to the lowering of the resolution. Thus, increase in the data size is suppressed by generating a single image in a pseudo manner by use of distance information of the subject 140 or parallax information.

Specifically, between an image 142a photographed by the camera 12a of the left point of view as illustrated in the diagram and an image 142b photographed by the camera 12b of the right point of view, deviation attributed to the parallax arises at the position of an image of the same subject 140. Thus, for example, only the image 142a is employed as the output target. In addition, information that represents the image positional deviation on the image is output as additional data. At the time of displaying, the image in the output image 142a is displaced by the deviation amount to generate the image 142b in a pseudo manner and thereby images that similarly involve the parallax can be displayed with a small data size.

The amount of positional deviation of the image of the same subject in the two images depends on the distance from the imaging surface to the subject. Therefore, it is conceivable that what is generally called a depth image having this distance as the pixel value is generated and is output together with the image 142a. A method is widely known in which the distance to a subject is acquired from the amount of deviation of a corresponding point in images photographed from points of view having a known interval on the basis of the principle of triangulation and a depth image is generated. The distance value obtained as the depth image may be associated with channels of RGB (Red, Green, Blue) colors of the image 142a to make 4-channel image data. Further, the amount of deviation itself may be output instead of the distance value.

On the other hand, the image obtained by shifting the image of the subject in the image 142a does not sufficiently express the image 142b actually photographed by the other camera 12b in many cases. For example, as illustrated in the diagram, in the case in which light from a light source 144 is reflected and a specularly reflected component with high angle dependence is observed only at the point of view of the camera 12b, the luminance of a region 146 in the image 142b becomes high compared with the image 142. Further, there is also the case in which, depending on the shape of the subject 140, a part that is visible only from the point of view of the camera 12b exists and occlusion occurs in the image 142a. In stereoscopic viewing, not only the parallax but also such a difference in how an image looks between the left and right images greatly affects a feeling of presence.

Thus, similarly to the narrow-angle high-resolution image in FIG. 7 and the additional image in FIG. 9, an image of the region that is not sufficiently expressed by only displacing an image and the map data that represents the region with which it should be combined are output and thereby the image 142b that is not output is accurately reproduced. FIG. 12 illustrates the configuration of functional blocks of an image data output device and a content reproduction device in the case in which a stereo camera is employed as the imaging device 12. In an image data output device 10a and a content reproduction device 20a illustrated in the diagram, only functions of processing relating to stereo images are illustrated. However, the functional blocks illustrated in FIG. 3 may be included.

The image data output device 10a includes a stereo image acquiring unit 150 that acquires data of stereo images from the imaging device 12, a depth image generating unit 152 that generates a depth image from the stereo images, and a partial image acquiring unit 154 that acquires the difference between an image obtained by shifting one of the stereo images by the parallax and an actual photographed image as a partial image. The image data output device 10a also includes a map generating unit 156 that generates map data that represents the region with which the partial image is combined and a data output unit 158 that outputs image data of the one of the stereo images, data of the depth image, data of the partial image, and the map data.

The stereo image acquiring unit 150 is implemented by the input unit 38, the CPU 23, the main memory 26, and so forth in FIG. 2 and acquires data of stereo images photographed by the stereo camera that configures the imaging device 12. As described above, each photographed image may be composed of partial images photographed by plural cameras that configure each camera of the stereo camera and are different in the angle of view. In this case, the stereo image acquiring unit 150 connects the partial images similarly to the output image generating unit 52 in FIG. 3 and generates one image data regarding each of the two points of view of the stereo camera. In this case, information relating to the connection position is supplied to the map generating unit 156.

The depth image generating unit 152 is implemented by the CPU 23, the GPU 24, the main memory 26, and so forth in FIG. 2. The depth image generating unit 152 extracts a corresponding point from stereo images and obtains a distance value on the basis of the principle of triangulation by acquiring the amount of deviation in the image plane, to generate a depth image. The depth image generating unit 152 may generate the depth image from information other than the stereo images. For example, by disposing a mechanism that irradiates a subject space with reference light such as infrared rays and a sensor that detects reflected light thereof in addition to the imaging device 12, the depth image generating unit 152 may generate the depth image by a technique of known TOF (Time Of Flight).

Alternatively, only a camera of one point of view may be employed as the imaging device 12, and the depth image generating unit 152 may estimate the distance of a subject by deep learning based on a photographed image and generate the depth image. The partial image acquiring unit 154 is implemented by the CPU 23, the GPU 24, the main memory 26, and so forth in FIG. 2. The partial image acquiring unit 154 calculates back the amount of deviation of an image from the depth image and acquires the difference in the pixel value between an image obtained by shifting the image in a first image of the output target in stereo images by the amount of deviation and a second image that is not output.

When the images 142a and 142b are defined as the first and second images, respectively, in the example of FIG. 11, the difference in the pixel value between the pseudo image obtained by shifting the image in the first image and the original image 142b becomes a large value in the region 146. Thus, the partial image acquiring unit 154 identifies the region that is not sufficiently expressed by the pseudo image obtained by shifting the image by extracting the region regarding which the difference is equal to or larger than a threshold. Then, the partial image acquiring unit 154 acquires the partial image that should be combined by clipping an image of a predetermined range, such as a circumscribed rectangle of this region, from the second image.

The map generating unit 156 is implemented by the CPU 23, the GPU 24, the main memory 26, and so forth in FIG. 2 and generates map data that represents the region that should be represented by the partial image in the plane of the second image. The map generating unit 156 may further generate map data that represents, regarding the plane of the first image, information relating to the joint, information for discrimination between moving image and still image, information for discrimination of the difference in the resolution, the region of an additional image, and so forth.

The data output unit 158 is implemented by the CPU 23, the main memory 26, the communication unit 32, and so forth in FIG. 2 and associates data of the first image in stereo images, data of the depth image, data of the partial image clipped from the second image, and map data with each other to output them to the content reproduction device 20a. The data output unit 158 also outputs data of the partial image that should be connected in order to complete the first image according to need. Alternatively, the data output unit 158 stores these pieces of data in a recording medium.

The content reproduction device 20a includes a data acquiring unit 162 that acquires data of the first image, data of the depth image, data of the partial image, and map data, a pseudo image generating unit 164 that generates a pseudo image of the second image on the basis of the depth image, a partial image combining unit 166 that combines the partial image with the pseudo image, and a data output unit 168 that outputs data of a display image. The data acquiring unit 162 is implemented by the communication unit 32, the CPU 23, the main memory 26, and so forth in FIG. 2 and acquires data of the first image, data of the depth image, data of the partial image, and map data output by the image data output device 10a. The data acquiring unit 162 may read out these pieces of data from a recording medium.

Further, in the case in which a joint exists in the first image, the data acquiring unit 162 may identify the joint with reference to the acquired map data and correct the joint as appropriate similarly to the display image generating unit 72 in FIG. 3. Besides, the data acquiring unit 162 may connect moving image and still image, wide-angle image and narrow-angle high-resolution image, wide-angle image and additional image, and so forth as appropriate as described above. The data acquiring unit 162 may execute the above-described processing regarding a region of the field of view corresponding to operation by the viewer through the input device 14b. Further, the data acquiring unit 162 outputs data of this region in the first image acquired and generated in such a manner to the data output unit 168.

The pseudo image generating unit 164 is implemented by the CPU 23, the GPU 24, the main memory 26, the input unit 38, and so forth in FIG. 2. The pseudo image generating unit 164 calculates back the amount of deviation of an image due to the parallax on the basis of the acquired depth image and generates the second image in a pseudo manner by shifting the image in the first image by the amount. At this time, the pseudo image generating unit 164 generates the pseudo image with the field of view corresponding to operation by the viewer through the input device 14b.

The partial image combining unit 166 is implemented by the CPU 23, the GPU 24, the main memory 26, and so forth in FIG. 2. The partial image combining unit 166 identifies the region that should be represented by a partial image with reference to the map data and combines the partial image with this region in the image generated by the pseudo image generating unit 164. Thereby, substantially the same image as the second image is generated. However, if the region that should be represented by a partial image does not exist in the field of view generated as the pseudo image, the partial image combining unit 166 may output this pseudo image as it is.

The data output unit 168 is implemented by the CPU 23, the GPU 24, the main memory 26, the output unit 36, and so forth in FIG. 2 and outputs, to the display device 16b, the first image of the field of view corresponding to operation by the viewer and the second image generated by the partial image combining unit 166 while setting the first and second images to such a format as to reach the left and right eyes of the viewer. For example, the data output unit 168 connects and outputs both in such a manner that an image for the left eye and an image for the right eye are displayed in regions divided into left and right two regions in the screen of a head-mounted display. This allows the viewer to enjoy stereoscopic video while freely changing the line of sight. The data output unit 168 may also output data of sound according to need besides the display image.

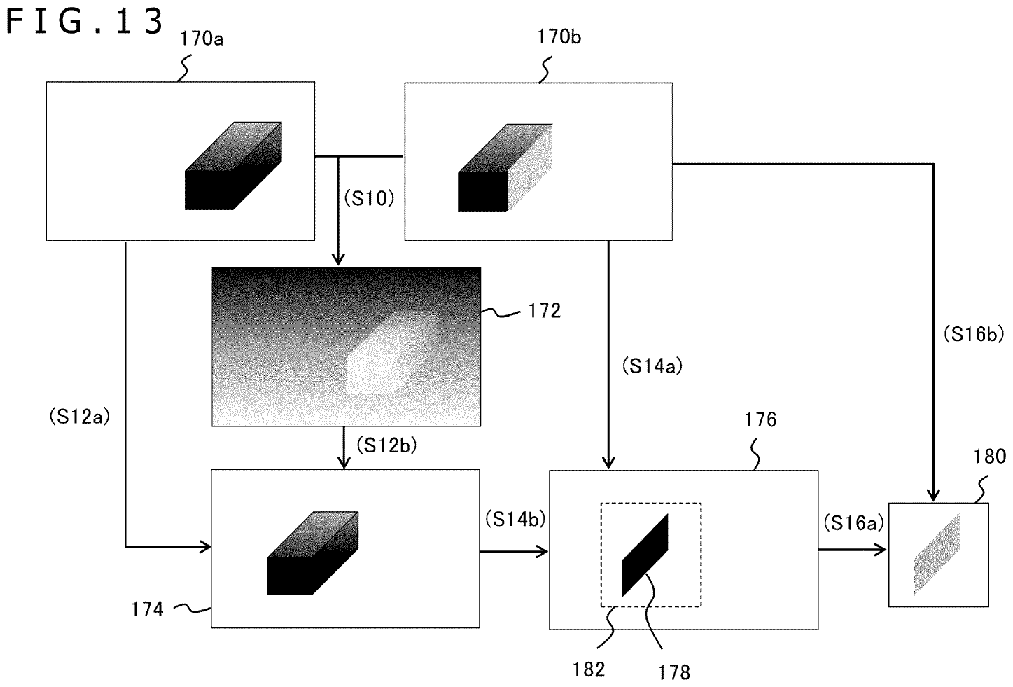

FIG. 13 schematically illustrates procedure of processing in which the image data output device 10a generates data to be output. First, the stereo image acquiring unit 150 acquires data of stereo images photographed by the imaging device 12. In the case in which each of the stereo images is further composed of images separately photographed, the stereo image acquiring unit 150 connects them to generate a first image 170a and a second 170b that configure the stereo images.

The depth image generating unit 152 generates a depth image 172 by using the first image 170a and the second image 170b (S10). In the example illustrated in the diagram, the depth image 172 in a format in which the pixel is represented with higher luminance when the distance from the imaging surface is shorter is schematically illustrated. The amount of deviation of an image in the stereo images and the distance of the subject are basically in an inverse proportional relation, and therefore, both can be mutually converted. Subsequently, the partial image acquiring unit 154 shifts an image in the first image 170a on the basis of the depth image 172 or the amount of deviation of the image due to the parallax, identified when it is acquired, and generates a pseudo image 174 of the second image (S12a, S12b).

Then, the partial image acquiring unit 154 generates a differential image 176 between the pseudo image 174 and the original second image 170b (S14a, S14b). The difference is hardly generated if reflected light, occlusion, and so forth peculiar to the point of view of the second image do not exist. In the case in which an image peculiar to only a single point of view like the region 146 in FIG. 11 exists, the image is acquired as a region 178 having a difference larger than a threshold.

The partial image acquiring unit 154 clips a region of a predetermined range including the region 178 in the second image 170b as a partial image 180 (S16a, S16b). Meanwhile, the map generating unit 156 generates map data in which a region 182 of a partial image like one illustrated by a dotted line in the differential image 176 is given a pixel value different from the other region.

As the region clipped as the partial image by the partial image acquiring unit 154, a region in which the amount of deviation (parallax value) of an image in the stereo images has been obtained in a predetermined range from a subject desired to be highlighted in stereoscopic video to be displayed, or a rectangular region including it, or the like may be employed. This region may be decided by using a technique of known semantic segmentation in deep learning.

The data output unit 158 outputs the first image 170a in the stereo images, the depth image 172, the map data, and data of the partial image 180 to the content reproduction device 20 or a recording medium. In the content reproduction device 20, the pseudo image generating unit 164 generates the pseudo image 174 by processing of S10,

S12a, and S12b illustrated in the diagram, and the partial image combining unit 166 refers to the map data and combines the partial image 180 with the relevant place to restore the second image 170b.

Even in total, the depth image 172, the map data, and the partial image 180 are data with a remarkably-small size compared with the color data of the second image 170b. Therefore, the transmission band and the storage area can be saved. When the saved data capacity is allotted to the data capacity of the first image 170a and thereby the first image 170a is output with the high resolution thereof kept, high-quality stereoscopic video can be allowed to be seen with a free line of sight by using stereo images with a vast angle of view.

According to the present embodiment described above, in a technique in which images photographed by plural cameras different in the angle of view like an omnidirectional image are connected to be used for displaying, the provision source of image data outputs map data that represents the position at which the images are connected together with the image data. For example, when the map data that represents the connection place is output together with the image after the connection, image distortion and discontinuity that possibly occur due to the connection can be efficiently detected and corrected in the content creation device or the content reproduction device that has acquired the map data. Due to this, necessary correction can be carried out with a light load without omission and content with high quality can be easily implemented.

Further, in the case of photographing and displaying a moving image, the region other than a partial region involving motion is set to a still image, and map data that represents discrimination between the regions of a moving image and the still image is output together with an image of the whole region that is first frames. Due to this, if only data of the partial moving image is transmitted and processed in the subsequent time, the same moving image can be displayed with higher efficiency than the case in which the moving image of the whole region is treated as the processing target. At this time, by intentionally executing noise processing for the region of the still image, the possibility of giving a sense of discomfort to the viewer becomes low.

Alternatively, an image with a wide angle and a low resolution and an image with a narrow angle and a high resolution are photographed and map data that indicates a region represented by the high-resolution image in the low-resolution whole image is output together with image data of both, to allow both images to be combined at the time of content creation and at the time of displaying. This can suppress the data size compared with the case in which an image whose whole region is set to the high resolution is output, and can display an image with higher quality than the case in which an image whose whole region is set to the low resolution. Alternatively, an additional image of explanation of a subject, subtitles, or the like is combined with a wide-angle image. By representing a position suitable for the combining as map data at this time, the additional information can be continued to be displayed at an appropriate position that does not obstruct the original image even when the line of sight is freely changed. Further, the additional information can be freely switched and can be set to the non-displayed state.

Further, in a technique in which stereoscopic viewing is implemented by causing left and right eyes to see stereo images photographed from left and right points of view, the second image is allowed to be restored by displacing an image of a subject in the first image in the stereo images by the parallax, and the data size is reduced. At this time, data of a region on the second image in which occlusion or reflection that is not expressed by only the displacement of the image is caused is associated with map data that represents the position of this region and these pieces of data are output. Due to this, although data of the second image is excluded from the output target, an image close to it can be restored, and therefore, stereoscopic video without a sense of discomfort can be displayed.

Due to these forms, it is possible to solve problems of trouble of the joint, which becomes a bottleneck for seeing an omnidirectional image while freely changing the line of sight, increase in the data size, the position at which additional information is displayed, and so forth. As a result, dynamic image expression can be implemented without delay and the deterioration of the quality irrespective of whether or not there are many resources. Further, by associating the data of the image with the map data on the side that provides the image, adaptive processing is enabled at a subsequent given processing stage, and the flexibility of the display form is enhanced even with a photographed image.

The description is made above based on the embodiments of the present invention. The above-described embodiments are exemplification and it is understood by those skilled in the art that various modification examples are possible regarding combinations of the respective constituent elements and the respective processing processes thereof and such modification examples also fall within the scope of the present invention.

### REFERENCE SIGNS LIST

1 Content processing system, 10 Image data output device, 12 Imaging device, 14a Input device, 16a Display device, 18 Content creation device, 20 Content reproduction device, 23 CPU, 24 GPU, 26 Main memory, 32 Communication unit, 34 Storing unit, 36 Output unit, 38 Input unit, 40 Recording medium drive unit, 50 Partial image acquiring unit, 52 Output image generating unit, 54 Data output unit, 56 Map generating unit, 60 Data acquiring unit, 62 Content generating unit, 64 Data output unit, 70 Data acquiring unit, 72 Display image generating unit, 74 Data output unit, 150 Stereo image acquiring unit, 152 Depth image generating unit, 154 Partial image acquiring unit, 156 Map generating unit, 158 Data output unit, 162 Data acquiring unit, 164 Pseudo image generating unit, 166 Partial image combining unit, 168 Data output unit.

### INDUSTRIAL APPLICABILITY

As described above, the present invention can be used for various devices such as a game machine, an image processing device, an image data output device, a content creation device, a content reproduction device, an imaging device, and a head-mounted direction, a system including it, and so forth.

1. An image data output device that outputs data of an image used for displaying, the image data output device comprising:
a partial image acquiring unit that acquires a plurality of partial images that configure the image;
an output image generating unit that generates data of an image to be output from the partial images after deciding a connection position of the partial images;
a map generating unit that generates map data that indicates the connection position; and
a data output unit that associates the data of the image to be output with the map data and outputs the data of the image to be output and the map data.

2. The image data output device according to claim 1, wherein
the partial image acquiring unit acquires a plurality of photographed images obtained by photographing a real space with different angles of view as the partial images,
the output image generating unit connects the plurality of photographed images on a basis of each angle of view to generate data of one image, and
the map generating unit represents a joint of the plurality of photographed images in the map data.

3. The image data output device according to claim 1, wherein
the partial image acquiring unit acquires a plurality of moving images obtained by photographing a real space with different angles of view as the partial images,
the output image generating unit generates data obtained by replacing a moving image as part of the plurality of moving images by a still image, and
the map generating unit represents discrimination between the moving image and the still image in the map data.

4. The image data output device according to claim 3, wherein
the output image generating unit switches a target to be replaced by the still image in the plurality of moving images according to contents of the image.

5. The image data output device according to claim 1, wherein
the partial image acquiring unit acquires a plurality of photographed images obtained by photographing a real space with different angles of view and different resolutions as the partial images, and
the map generating unit represents discrimination of the plurality of photographed images in the map data.

6. The image data output device according to claim 5, wherein
the partial image acquiring unit acquires a photographed image of a whole region used for displaying and a narrow-angle high-resolution image having a narrower angle of view and a higher resolution than the photographed image of the whole region, and
the map generating unit changes the map data in such a manner that the change in the map data corresponds to change in the angle of view of the narrow-angle high-resolution image.

7. The image data output device according to claim 1, wherein
the partial image acquiring unit acquires an image that represents additional information for the image used for displaying as the partial image, and
the map generating unit represents discrimination of the image that represents the additional information in the map data.

8. The image data output device according to claim 7, wherein
the map generating unit associates an image that represents a plurality of pieces of the additional information displayed with switching with one region of the map data.

9. The image data output device according to claim 1, further comprising:
a stereo image acquiring unit that acquires stereo images composed of a first image and a second image photographed from left and right points of view having a known interval, wherein
the partial image acquiring unit acquires an amount of deviation of an image of a same subject in the stereo images and generates a pseudo image of the second image obtained by moving the image in the first image by the amount of deviation, and then clips, as the partial image, a region of a predetermined range including a place at which a difference from the pseudo image is equal to or larger than a predetermined value in the second image,
the map generating unit represents the region of the predetermined range in a plane of the second image in the map data, and
the data output unit outputs data of the first image, data relating to the amount of deviation, data of the partial image, and the map data.

10. A content creation device comprising:
a data acquiring unit that acquires data of an image obtained by connecting a plurality of partial images and map data that indicates a joint of the partial images;
a content generating unit that refers to the map data and corrects the image regarding the joint and then employs the corrected image as data of content; and
a data output unit that outputs the data of the content.

11. A content reproduction device comprising:
a data acquiring unit that acquires data of a plurality of partial images that configure an image used for displaying and map data that indicates a connection position of the partial images;
a display image generating unit that refers to the map data and connects the partial images in a region corresponding to a line of sight to generate a display image; and
a data output unit that outputs the display image to a display device.

12. The content reproduction device according to claim 11, wherein
the display image generating unit refers to the map data and identifies a region in which the partial image is a moving image and a region in which the partial image is a still image and updates an image by using acquired data of a moving image in the region of the moving image.

13. The content reproduction device according to claim 12, wherein
the display image generating unit superimposes pseudo noise on the region of the still image.

14. The content reproduction device according to claim 11, wherein
a plurality of additional images are associated with a region of one partial image in the map data, and
the display image generating unit switches the additional images that are connected according to operation by a viewer.

15. The content reproduction device according to claim 11, wherein
the data acquiring unit acquires a first image in stereo images composed of the first image and a second image photographed from left and right points of view having a known interval, data relating to an amount of deviation of an image of a same subject in the stereo images, data of a region of a predetermined range of the second image including a place at which a difference from a pseudo image of the second image obtained by moving the image in the first image by the amount of deviation is equal to or larger than a predetermined position, and map data that indicates the region of the predetermined range in a plane of the second image,
the display image generating unit generates the pseudo image by using the first image and the data relating to the amount of deviation and restores the second image by combining the data of the region of the predetermined range with the region indicated by the map data in the pseudo image, and
the data output unit outputs the first image and the second image.

16. An image data output method comprising:
by an image data output device that outputs data of an image used for displaying,
acquiring a plurality of partial images that configure the image;
generating data of an image to be output from the partial images after deciding a connection position of the partial images;
generating map data that indicates the connection position; and
associating the data of the image to be output with the map data and outputting the data of the image to be output and the map data.

17. A content creation method comprising:
by a content creation device,
acquiring data of an image obtained by connecting a plurality of partial images and map data that indicates a joint of the partial images;
referring to the map data and correcting the image regarding the joint and then employing the corrected image as data of content; and
outputting the data of the content.

18. A content reproduction method comprising:
by a content reproduction device,
acquiring data of a plurality of partial images that configure an image used for displaying and map data that indicates a connection position of the partial images;
referring to the map data and connecting the partial images in a region corresponding to a line of sight to generate a display image; and
outputting the display image to a display device.

19. (canceled)

20. (canceled)

21. (canceled)
